(19) United States
(12) Patent Application Publication
(10) Pub. No.: US 2007/0297882 A1
(43) Pub. Date: Dec. 27, 2007

(54) Gondola car material handler

(76) Inventors: Christopher M. Villar, Georgetown, TX (US); John B. Messer, Belton, TX (US); Thomas R. Schwertner, Jarrell, TX (US); Charles Wayne Aaron, Hutto, TX (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/472,952

(22) Filed: Jun. 22, 2006

(51) Int. Cl. B65F 9/00

(52) U.S. Cl. 414/333

(57) ABSTRACT

A material handler is disclosed that is adapted to travel along the top of an open top railroad car, like a gondola car, to load or unload the railroad car. The material handler may include an excavator connected to an assembly frame, the assembly frame being adapted to ride on the top of the side walls of the open top railroad car. The assembly frame may include a front wheel mount and a rear wheel mount that moves the material handler along the top of the open top railroad car. The material handler may include hydraulic links that connect the wheel mounts to the frame assembly. The hydraulic links may provide the vertical movement of the wheel mounts with respect to the frame assembly. The vertical movement of the wheel mounts may allow the material handler to travel between adjacent open top railroad cars having differing wall heights.

### BACKGROUND OF THE INVENTION

1. Field of the Invention

The present invention relates generally to a material handler for the loading and unloading of an open top railroad car, such as a gondola car. Specifically, an excavator may be connected to an assembly frame adapted to travel along the top of the side walls of an open top railroad car. The assembly frame may include a front wheel mount and a rear wheel mount that allows the material handler to move in both directions along the top of the open top railroad car. Further, hydraulic links may connect the wheel mounts to the frame assembly, which provides for the vertical movement of the wheel mounts with respect to the assembly frame. The vertical movement of the wheel mounts may allow the material handler to travel between adjacent railroad cars having different wall heights.

2. Description of the Related Art

An important issue in the railroad transport industry is the loading and unloading of freight from rail cars. Thus, there have been a number of solutions proposed in an attempt to provide for the more efficient loading and/or unloading of rail cars. In particular, a number of different material handlers have been designed in an effort to more efficiently load or unload material from an open top rail car, such as a gondola car or open top hopper.

U.S. Pat. No. 4,175,902 discloses a mobile apparatus that may be used to unload an open top rail car. The mobile apparatus consists of a backhoe, which includes a front boom with a shovel and a rear boom, adapted for travel on top of an open top rail car. The backhoe is modified such that it may be used to load or unload an open top rail car, but can also operate as a backhoe when located on the ground. Specifically, the backhoe is adapted with a pair of foldable outrigger arms located near the rear of the backhoe. A supportive foot and a downward bracket are located at the end of each outrigger arm. When the backhoe is on the rail car, the arms are extended outward such that the support foot of each arm rests on one of the side walls of the rail car. Further, the downward bracket of each outrigger arm is so positioned in an attempt to prevent the backhoe from falling off the side of the rail car.

The front boom of the backhoe is also adapted for travel along the top of an open top rail car. For example, each side of the front boom shovel is adapted to include a supportive foot and bracket. The support foot is positioned to ride along the top of the rail car with the bracket located downward in an attempt to prevent the backhoe from falling off the side of rail car. Preferably, a winch is mounted in the bucket to move the backhoe. The winch line is connected to a front portion of the train and the rotation of the winch pulls the backhoe along causing the backhoe to slide along the top of the rail cars on the four support feet. This method of travel requires the backhoe to start unloading at the rear of a string of rail cars and progressively unload each car as it moves forward. An alternative method of movement along the rail car is disclosed using the rear boom to push or pull the backhoe and slide it along the rail car. Using the rear boom to push or pull the backhoe handler is a rather slow method of travel and also increases the load and/or unload time of the railroad car due to the increased use of the boom.

The configuration of the supporting feet on the backhoe and the high center of gravity of the backhoe may not provide adequate stability of the backhoe unloader to ensure proper safety of the backhoe operator. This may especially be a problem when the backhoe unloader is traversing between adjacent rail cars having different wall heights. The difference in wall height between the two rail cars decreases the stability of the backhoe. For example, if the difference of height between rail cars is large it may cause the backhoe to be at an angle that may prevent the support foot from being flush with the wall of the rail car.

The general operation of the backhoe also may compromise the stability of the apparatus on a rail car. For example, as the rear boom is used to load or unload material, a tremendous force is applied to supporting feet of the bucket, which may cause the bucket to tip backwards away from the backhoe. The movement of the bucket also puts a tremendous strain on the hydraulics of the front boom, which can cause excessive wear on the hydraulics possibly causing premature failure. The movement of the bucket due to the load or unloading of material creates further instability of the backhoe on top of the rail car. The location of the rear support feet may also not provide sufficient rigidity to ensure proper stability of the backhoe. The rear support feet are located on the foldable outrigger arms positioned inside of the pivot point of the rear boom.

U.S. Pat. Nos. 5,527,144 and 5,628,606 disclose an alleged improved backhoe unloader for use on an open top rail car. Like U.S. Pat. No. 4,175,902 the disclosed backhoe includes a front boom with a shovel and a rear boom and is adapted for travel on top of an open top rail car. In an attempt to increase the stability of the backhoe, a third set of support feet is provided between the wheels of the backhoe. The third set of support feet are attached to a center beam attached transversely to the bottom of the backhoe. While this may provide more overall rigidity to the support feet and thus more stability, it does not help with stability to the apparatus while transferring between rail cars, especially rail cars of different heights.

U.S. Pat. Nos. 5,527,144 and 5,628,606 also disclose an alleged improvement to the front boom with shovel linkage. Specifically, a stop block is welded to the rear of the front bucket. Additionally a removable stop block is attached to the top of the front boom, which is located such as to mate the stop block welded to the bucket. The locations of the blocks limit the backwards travel of the bucket, but the stop block must be removed before the front shovel can be fully used in its backhoe capacity.

While the patents disclose modifications to the backhoe in an attempt to improve the stability of the backhoe while on a rail car, the backhoe still has the same shortcomings regarding the movement of the apparatus on top of a rail car. Namely, the backhoe still moves either via a winch and wireline or by using the rear boom to push the backhoe along the rail car. Additionally, the improved backhoe is still relatively unstable when transferring between cars of differing wall heights.

The above mentioned material handlers all have fixed operator cabs. Although the material handlers all include booms that are able to rotate to the side of a rail car, the fixed cab does not allow the operators to always directly face the end of the working boom. Further, the rotation of the cab would lengthen the reach of the working boom.

Brandt Engineered Products also has designed a material handler adapted to load and unload material from an open top rail car. The material hander consists of an excavating unit adapted to ride along a movable rail. The movable rail is connected to four hydraulic legs with feet and also includes four hydraulic safety clamps. Additionally, the excavating unit itself includes four hydraulic legs with feet. To move the material handler, the hydraulic legs of the excavating unit are extended until the four feet of the moveable rail are lifted off the rail car. The rail is then hydraulically moved forward or backwards with respect to the excavating unit. When the end of the movable rail reaches the excavating unit the hydraulic legs of the excavating unit are retracted until the entire unit is supported on the rail car by the four feet of the movable beam. The excavating unit unloads or loads the rail car as it moves along the movable rail, which is presently stationary. Once the excavating unit reaches the end of the movable rail, the above discussed process is repeated until all of the rail cars have been unloaded and/or loaded.

The use of a movable rail may prevent Brandt's excavating unit from traversing between adjacent rail cars having differing wall heights. For example, they length of the beam and the hydraulic legs may not allow the excavating unit to incline or decline at the requisite angle to travel between rail cars having differing wall heights. Also the movement of Brandt's excavating unit along the rail car is slow and tedious.

The above discussed material handler requires transportation to the rail cars via truck and/or trailer. It would be beneficial if after unloading the open top rail cars of a train, the material handler could be transported within an empty open top rail car to the next unloading and/or loading location. This would allow efficient transportation of the material handler between locations.

In light of the foregoing, it would be desirable to provide a material handler that can move in either direction along an open top rail car while loading or unloading material. Additionally, it would be desirable to provide a material handler that is specifically adapted to travel between adjacent open top rail cars having different wall heights. It would be desirable to provide material handler that has wheels that move it along an open top rail car allowing for the more rapid unloading and/or loading of a rail car. Also it would be desirable to provide a material handler that allows for the rotation of the cab to lengthen the reach of a working boom as well as allow the operator to always face the working boom. It would be desirable for a material handler to have the pivot point of a working boom located within the support points of the material handler. It would also be desirable for the width of the rail car supports of a material handler to be highly adjustable. It would be desirable to provide a material handler that could load or load an open top rail car while spanning between two open top rail cars having differing wall heights. It is also desirable to provide a material handler that is capable of be transported in an open rail car after it has unloaded the payload from the open rail car.

The present invention is directed to overcoming, or at least reducing the effects of, one or more of the issues set forth above.

### SUMMARY OF THE INVENTION

The present application discloses a material handler for loading or unloading of cargo from an open top railroad car that includes an excavator, that includes at least one boom, connected to a frame assembly, the frame assembly including a front wheel mount and a rear wheel mount. The front wheel mount may include two front wheels and the rear wheel mount includes two rear wheels.

In one embodiment, a material handler is disclosed for loading or unloading of cargo from an open top railroad car the material handler may include an excavator, that includes at least one boom, connected to a frame assembly, the frame assembly includes a front wheel mount, which includes two front wheels, a rear wheel mount, which includes two rear wheels, and at least one motor to drive. The front wheel mount may include two front wheels and the rear wheel mount includes two rear wheels a first motor mounted on the frame assembly to drive at least two wheels. The material handler may further include a second motor mounted on the frame assembly to drive at least two additional wheels.

In one embodiment, the front wheel mount and the rear wheel mount of the material handler may each independently raise or lower with respect to the frame assembly. The material handler may travel between two adjacent open top railroad cars of differing heights. In an embodiment, the material handler may be adapted to travel between two adjacent open top railroad cars having walls that differ in height up to approximately three feet.

The excavator of the material handler may be able to swivel or rotate about a vertical axis with respect to the frame assembly. The width between the two front wheel mount and the width between the two rear wheels of the material handler may both be adjustable. Further, the width between the two front wheels and the width between the two rear wheels of the material handler may be adapted such that the material handler can be transported inside or within an open top railroad car, such as a gondola car for example. The width between the two front wheels and the width between the two rear wheels of the material handler may be up to approximately 10.5 feet or as narrow as 8 feet.

In one embodiment, the material handler may include an excavator, that includes at least one boom, connected to a frame assembly, the frame assembly includes a front wheel mount having two wheels and a set of clamps, a rear wheel mount having two wheels and a set of clamps, at least one motor to drive the two front wheel, and at least one motor to drive the two rear wheels. The set of clamps on the front wheel mount may be for preventing the excess lateral movement of the frame assembly. Likewise, the set of clamps on the rear wheel mount may be for preventing the excess lateral movement of the frame assembly. The two front wheels and the two rear wheels of the material handler may be used to move the material handler along the top of the open top railroad car.

One embodiment discloses a material handler for loading and unloading an open top railroad car comprising an excavator and a frame assembly, wherein the frame assembly is rotatably connected to the excavator, a front wheel mount, the front wheel mount including two front wheels and being linked to the frame assembly, wherein the width of the front wheel mount is adjustable and the front wheel mount may move vertically in respect to the frame assembly, a rear wheel mount, the rear wheel mount including two rear wheels and being linked to the frame assembly, wherein the width of the rear wheel mount is adjustable and the rear wheel mount may move vertically in respect to the frame assembly, at least one motor to drive the two front wheels; and at least one motor to drive the two rear wheels.

The link between the front wheel mount and the frame assembly of the material handler may be a parallelogram link. The link between the rear wheel mount and the frame assembly of the material handler may also be a parallelogram link. The parallelogram link provides that the wheels remain level as the wheel mount is raised or lowered with respect to the frame assembly. The parallelogram links may be hydraulically or pneumatically actuated. The front wheel mount and the rear wheel mount of the material handler may each be comprised of telescopic tubing. The excavator of the material handler may include a hydraulic generator. Further, the excavator may include magnetic means for loading or unloading an open top rail car.

One embodiment of the present disclosure is a material handler for loading and unloading an open top railroad car that include means for loading or unloading material from the open top railroad car, a frame having a first end and a second end, the frame being rotatably connected to the means for loading or unloading material, a first means for moving the material handler along an open top railroad car, and a second means for moving the material handler along the top of the open top railroad car. The first means for moving the material handler may be connected to the first end of the frame. The second means for moving the material handler may be connected to the second end of the frame. The means for loading or unloading material may be an excavator with at least one boom. The excavator may be able to swivel with respect to the means for moving the material handler. The first means for moving the material handler may be a front set of wheels. The second means for moving the material handler may be a rear set of wheels. The wheels of the material handler may be driven by an electric motor or by other means that would be appreciated by one of ordinary skill in the art having the benefit of this disclosure.

The material handler may include means for independently raising or lowering the front wheels and the rear wheels. The means for independently raising or lowering the front wheels and rear wheels may be a linkage or arm between the wheels and the frame. The linkage may be hydraulically or pneumatically actuated. The material handler may include means for driving at least one of the front wheels and may include means for driving at least one of the rear wheels. The means for driving at least one of the front wheels and the means for driving at least one of the rear wheels may be a motor.

One embodiment of the present disclosure is a method of loading or unloading an open top rail car that includes positioning a material handler to the approximate height of the open top rail car. The material handler may include a boom, a set of front wheels, and a set of rear wheels. The method further includes extending the boom into the rail car, positioning the front end of the material handler by adjusting the position of the boom, moving the material handler towards the rail car until the set of front wheels is over the rail car by adjusting the position of the boom, lowering the set of front wheels onto the rail car by adjusting the position of the boom, moving the material handler onto the rail car until the rear wheels are over the rail car by adjusting the position of the boom, lowering the set of rear wheels onto the rail car by adjusting the position of the boom, and using the boom to load material into the rail car or to unload material out of the rail car.

The method may further include the step of moving the material handler along the rail car. At least one of the set of front wheels and set of rear wheels may be used to move the material handler along the rail car. The method of loading or unloading an open top rail car may include a material handler wherein the width of the front wheels and width are the rear wheels of the material handler are adjustable. The method may further include the step of lowering the material handler into an empty open top rail car for transportation of the material handler. Further, the method may also include the step of engaging a set of front clamps around a top cord of the rail car. Likewise, there may be a step of engaging a set of rear clamps around the top cord of the rail car.

In another embodiment, a method of transferring a material handler between a first car and a second car is disclosed wherein the first car and second car have differing wall heights. The method includes moving the material handler along the first car, wherein a first set of wheels of the material handler is located at the edge of the first car adjacent to the second car, positioning a boom of the material handler into the second car, lifting a first end of the material handler with the boom, vertically positioning the first set of wheels to be aligned the wall height of the second car, moving the material handler until the first set of wheels is located over the second car, lowering the first end of the material handler until the first set of wheels is on the second car, moving the material handler along the first car, wherein a second set of wheels is located at the edge of the first car adjacent to the second car, positioning the boom of the material handler into the first car, lifting the second end of the material handler with the boom, vertically positioning the second set of wheels to be aligned the wall height of the second car, moving the material handler until the second set of wheels is located over the second car, and lowing the second end of the material handler until the second set of wheels is on the second car.

Another embodiment of the present disclosure is a frame assembly to be connected to an excavator having at least one boom, the combination for loading and unloading cargo from an railroad car. The frame assembly may be comprised of a front wheel mount having a pair of front wheels, a rear wheel mount having a pair of rear wheels, a first motor for driving the pair of front wheels, a first power unit for selectively adjusting the vertical position of the front wheel mount, and a second power unit for selectively adjusting the width between each of the front wheels. The frame assembly may further include a second motor for driving the pair of rear wheels. The frame assembly may also include a third power unit for selectively adjusting the vertical position of the rear wheel mount and a fourth power unit for selectively adjusting the width between each of the rear wheels. The power unit may be a number of applicable devices, such as hydraulic cylinders, as would be appreciated by one of ordinary skill in the art having the benefit of this disclosure.

### BRIEF DESCRIPTION OF THE DRAWINGS

FIG. 1 is an isometric view of one embodiment of the frame assembly 10 of the present disclosure.

FIG. 2 is a top view of the frame assembly 10 of FIG. 1.

FIG. 3 is a side view of the frame assembly 10 of FIG. 1.

FIG. 4 is a front end view of the frame assembly 10 of FIG. 1.

FIG. 5 is an isometric view of one embodiment of the material handler 100 comprised of a frame assembly 10 rotatably connected to an excavator 80.

FIG. 6 is an isometric view of the material handler 100 of FIG. 5 wherein the width of the front wheel mount 30 and the rear wheel mount 20 has been increased.

FIG. 7 is a side view of the material handler 100 on top of a gondola car 200.

FIG. 8 is an isometric view of the material handler 100 on top of a gondola car 200.

FIG. 9 is a side view of the material handler 100 running on the ground using crawler tracks 50.

FIGS. 10A-10G depict the material handler 100 traversing between a first rail car 250 to second rail car 300 having a higher wall height than the first rail car 250.

FIGS. 11A-11D depict the material handler 100 being lowered into a gondola car 200 for transportation to another location.

While the invention is susceptible to various modifications and alternative forms, specific embodiments have been shown by way of example in the drawings and will be described in detail herein. However, it should be understood that the invention is not intended to be limited to the particular forms disclosed. Rather, the intention is to cover all modifications, equivalents and alternatives falling within the spirit and scope of the invention as defined by the appended claims.

### DESCRIPTION OF ILLUSTRATIVE EMBODIMENTS

Illustrative embodiments of the invention are described below as they might be employed in the use of a material handler adapted to unload or load an open top rail car, such as a gondola car. In the interest of clarity, not all features of an actual implementation are described in this specification. It will of course be appreciated that in the development of any such actual embodiments, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Further aspects and advantages of the various embodiments of the invention will become apparent from consideration of the following description and drawings.

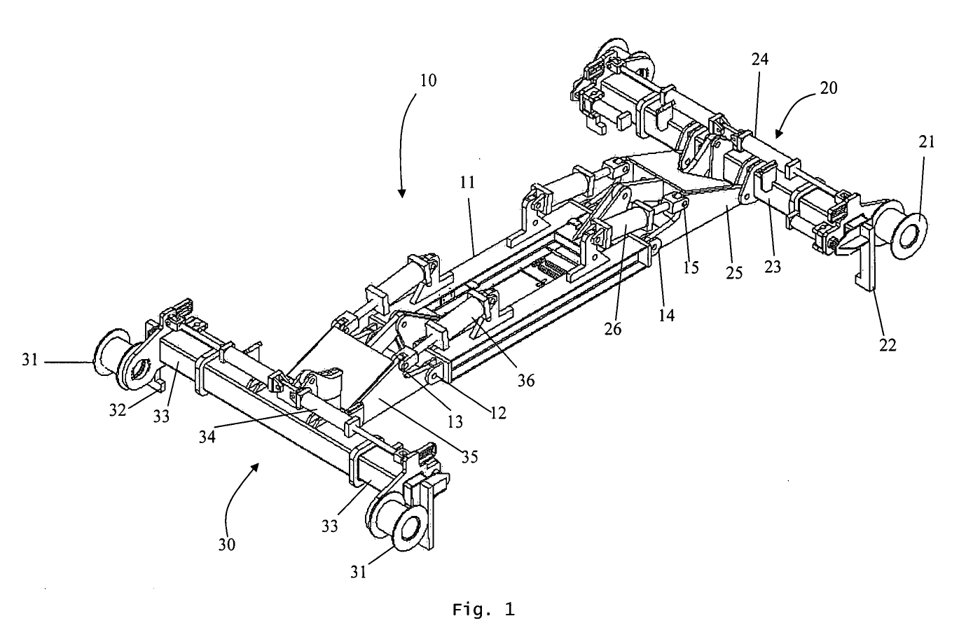

FIG. 1 shows a frame assembly 10 that is comprised of a frame member 11, a front wheel mount 30, and a rear wheel mount 20. The front wheel mount 30 is connected to the frame member 11 by a front linkage 35. In one embodiment, the linkage 35 may be a parallelogram linkage. The front linkage 35 is pivotably connected to both the frame member 11 and a front hydraulic cylinder 36. As shown in FIG. 1, the lower connection 12 connects the front linkage 35 to the frame member and the upper connection 13 connects the front linkage 35 to a power unit such as the front hydraulic cylinder 36. By activating the power unit, such as the expansion contraction of the front hydraulic cylinder 36, the front linkage 35 and the front wheel mount 30 is made to raise or lower with respect to the frame member 11. The front linkage 35 pivots about the lower connection point 12 when the front hydraulic cylinder 36 is actuated. The use of a parallelogram linkage 35 helps to keep the front wheels 31 level while the front wheel mount 30 level is raised or lowered. The frame assembly 10 of FIG. 1 illustrates two power units as two front hydraulic cylinders, but the number of power units, such as hydraulic cylinders, could be varied as would be appreciated by one of ordinary skill in the art having the benefit of this disclosure. The front wheel mount 30 includes a front clamp 32, which helps hold the material handler on top of an open top rail car. A front clamp 32 may be located on both ends of the front wheel mount 30. The front clamp 32 may be adapted to be moved between an outward disengaged position and an inward engaged position. A front cylinder 37 may be used to move the front clamp 32 between the engage and disengage positions.

The rear wheel mount 20 is identically connected to the frame member 11 as the front wheel mount 30. The rear linkage 25 is connected to both the frame member 11 and the rear wheel mount 20. The movement of the rear hydraulic cylinder 26 causes the rear linkage 25 to pivot about connection point 14 which raises or lowers the rear wheel mount 20. The rear wheel mount 20 also includes a rear clamp 22 that may be moved between an outward disengaged position and an inner engaged position. A rear cylinder 27 may be used to move the rear clamp 22 between the disengaged and engaged positions.

The front wheels 31 on the front wheel mount 30 may be driven by a hydraulic motor. Alternatively a different type of motor, such as an electric motor, could be used to drive the wheels of the frame assembly as would be appreciated by one of ordinary skill in the art having the benefit of this disclosure. A number of different configurations could be used, such as a gear or belt drive, in connection with a hydraulic motor to drive the front wheels 31 as would be appreciated by one of ordinary skill in the art having the benefit of this disclosure. The rear wheels 21 may also be driven by a hydraulic motor. In some embodiments, a separate motor may be used to drive each individual wheel on the material handler. The motor may be mounted to the frame assembly. In one embodiment, the motor may be mounted to a gearbox mounted to the inside of the wheel. The width between the front wheels 31 may be adjustable. For example as shown in FIG. 1, adjustable telescopic tubing 33 may connect the front wheels 31 of the front wheel mount 30. A second power unit, such as a hydraulic cylinder 34 may be used to retract or expand the adjustable telescopic tubing 33 to selectively adjust the width between the front wheels 31. Adjustable telescopic tubing 23 and a hydraulic cylinder 24 may be used to selectively adjust the width between the rear wheels 21 of the rear wheel mount 20.

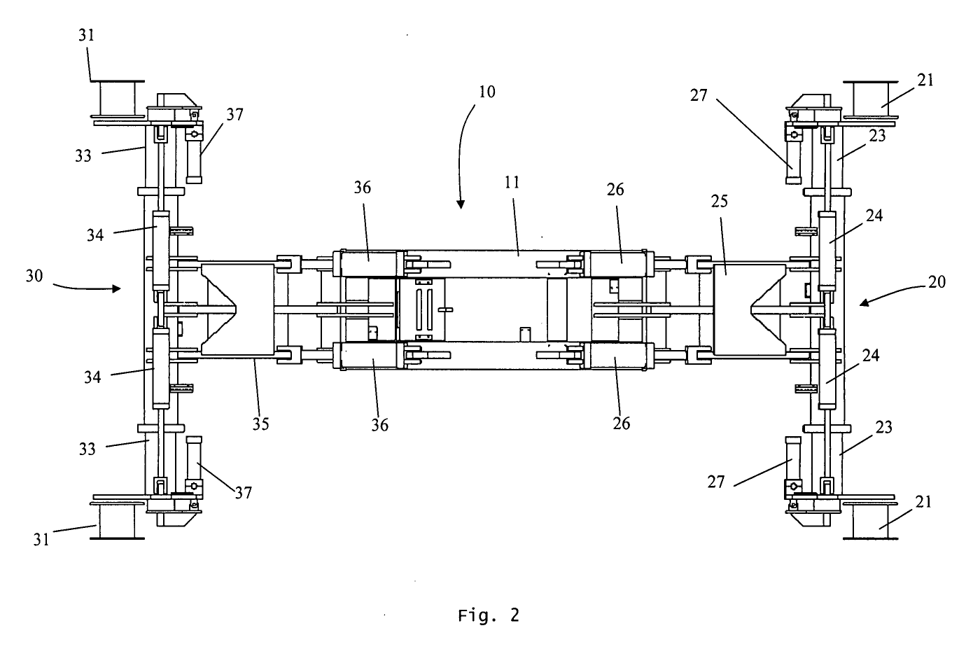

FIG. 2 shows a top view of the frame assembly 10 of FIG. 1. The frame member 11 is connected to the front wheel mount 30 and the rear wheel mount 20 via the front linkage 35 and the rear linkage 25. The front wheels 31 of the front wheel mount 30 may be driven by a motor and the rear wheels 21 of the rear wheel mount 20 may be driven by a motor. The motor may be mounted to a gear box mounted on the inside of each wheel, but alternatively one motor could be used to drive multiple wheels. FIG. 2 shows adjustable telescopic tubing 33, 23 extended away from the centerline of the frame member 11 to increase the distance between the front wheels 31 and to increase the distance between the rear wheels 21. The maximum distance between the wheels is limited by the length of telescopic tubing 23, 33 and the length of hydraulic cylinders 24, 34 which could be varied to need as would be recognized by one of ordinary skill in the art having the benefit of this disclosure. In one embodiment, the width between the wheels may vary from 8 feet up to 10.5 feet.

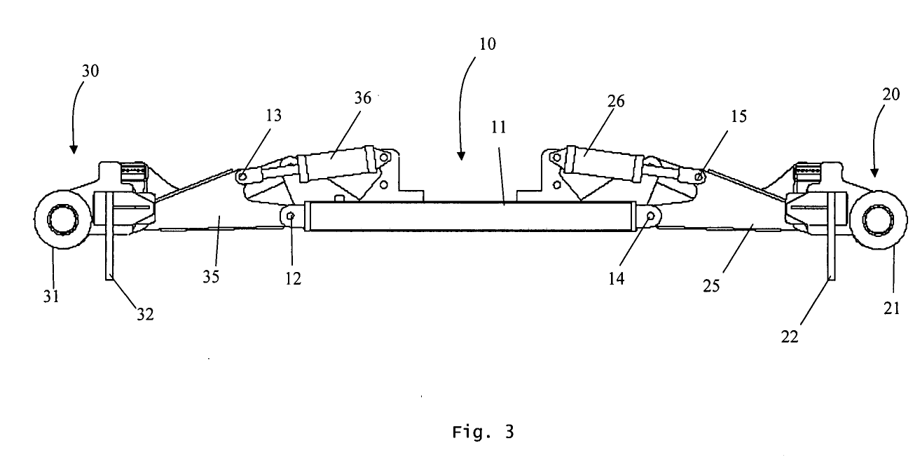

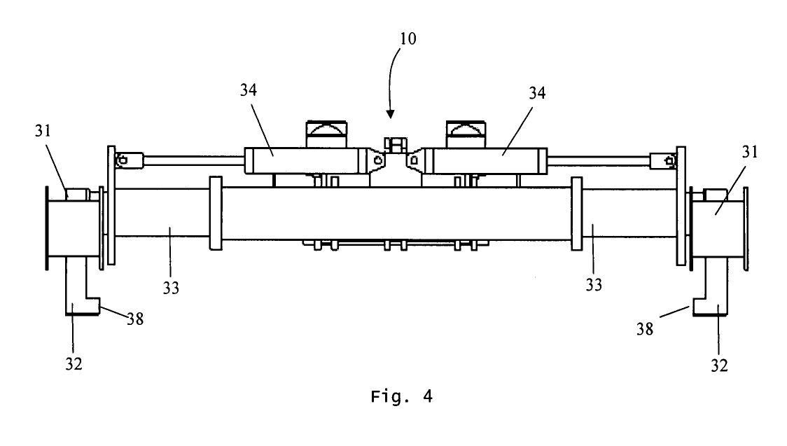

FIG. 2 shows the front clamp 32 and the rear clamp 22 both in the inward engaged position. The material handler may include power units, such as cylinders 27, 37, to move the clamps 22, 32 between the inward engage position and the outward disengage position. When in the engaged position, a portion 38 of the clamp extends towards the center of the frame assembly as shown in FIG. 4. The portion 38 of the clamp is positioned under the top cord of the open top rail car and prevents the material handler from falling from the rail car. FIG. 3 shows the side view of the embodiment of FIG. 1. FIG. 3 illustrates the pivotable connection 12 between the front linkage 35 and the frame assembly 10. FIG. 3 also illustrates the pivotable connection 14 between the rear linkage 25 and the frame assembly 10. A power unit, which may be a front cylinder 36 for example, may be connected to the front linkage 35 at an upper connection point 13 and be used to pivot the front linkage 35 about the pivotable connection 12. Likewise, a power unit, such as a rear cylinder 26 for example, may be connected to the rear linkage 25 at an upper connection point 15 and be used to pivot the rear linkage 25 about the pivotable connection 14.

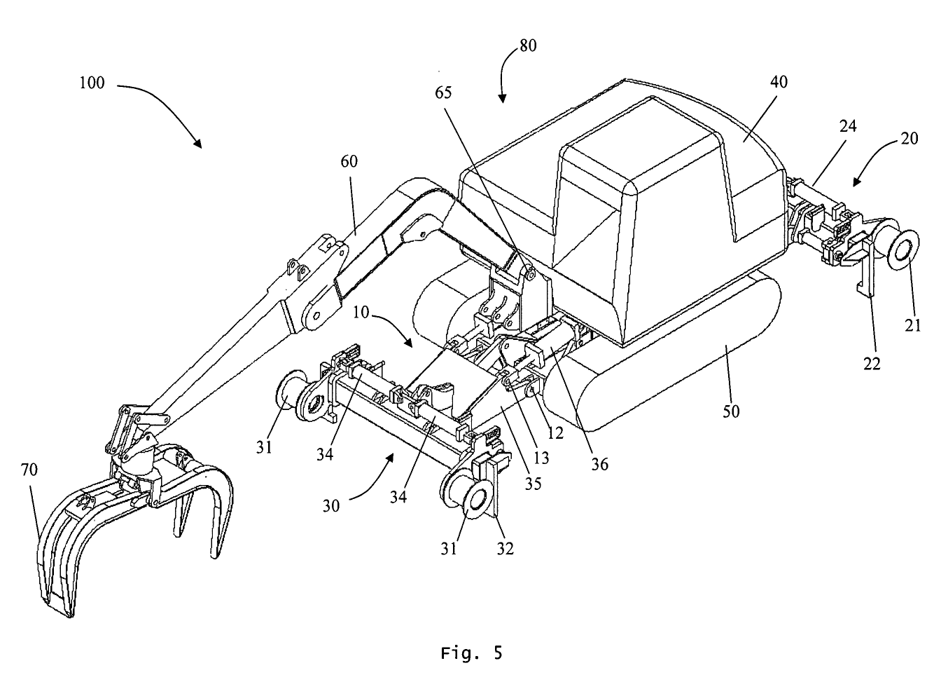

FIG. 5 shows an isometric view of one embodiment of the material handler 100. The material handler 100 includes an excavator 80 that is connected to a frame assembly 10. The frame assembly 10 may be pinned to the chassis of the excavator 80. The excavator includes an operator cab 40, means for moving the excavator when on the ground such as a pair of crawler tracks 50, a boom 60, and means for loading or unloading material such as a magnet or a grapple 70 as shown in FIG. 5. The connection of the excavator 80 to the frame assembly 10 is adapted such that the excavator cab 40 and boom 60 may swivel 360 degrees. This allows the reach of the boom to be extended to the side of a rail car in comparison to a fixed point excavator.

The cab 40 of the excavator 80 includes controls to operate the boom 60, grapple 70, and to swivel the cab 40. Additionally, the cab 40 includes controls to operate the hydraulic cylinders 26, 36 of the frame assembly 10 to raise or lower the wheel mounts 20, 30 and to actuate the hydraulic cylinders 24, 34 in order to change the width of the front wheels and the rear wheels. The cab 40 also includes controls to engage or disengage the wheel clamps 22,.32 and controls to operate the motors in order to rotate the wheels to move the material handler 100 along the top of an open top rail car. These controls could be in various forms, such as pedals, buttons, toggle switches and/or joystick controls, as would be appreciated by one of ordinary skill in the art having the benefit of this disclosure.

The wheels 21, 31 of the material handler 100 are adapted to ride along the top of an open top rail car. The wheels are adapted to prevent the material handler 100 from falling off of the rail car. The front and rear clamps 22, 32 are also adapted to prevent the material handler from falling off of the rail car. When engaged a portion 28, 38 of the clamps 22, 32 is located underneath the top cord of the open top rail car which prevents the material handler 100 from falling off the rail car as would be appreciated by one of ordinary skill in the art having the benefit of this disclosure. The frame assembly 10 is also adapted to provide stability to the material handler 100 by the location of the wheel mounts 20, 30. The front wheel mount 30 and rear wheel mount 20 are both located outside of the excavator 80 and as such provide adequate stability to the material handler 100. As the boom 60 of the excavator 80 operates, a large force may be applied to the boom pivot point 65 of the excavator 80. As shown in FIG. 5, the boom pivot point 65 is located in between the front wheel mount 30 and rear wheel mount 20. The location of the pivot point 65 aids in decreasing instability due to the unloading and loading operation of the boom 60.

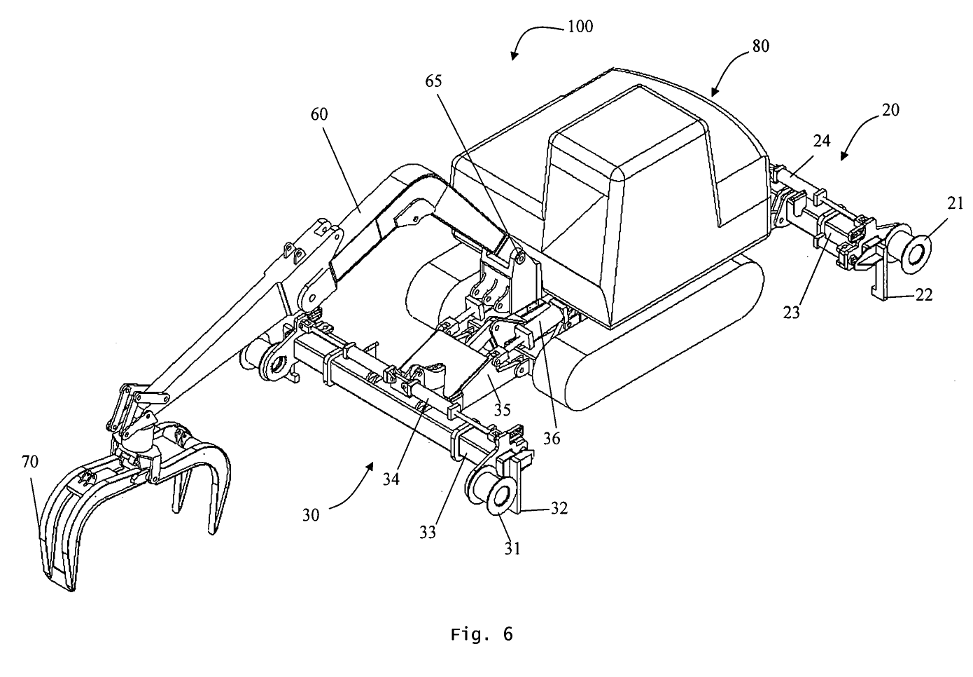

The telescopic tubing 23, 33 of the material handler 100 shown in FIG. 6 may be retracted minimizing the width of the front and rear wheels 21, 31, as shown in FIG. 5. The material handler may be transported inside an open top rail car when its wheels have been filly retracted. In FIG. 6, the telescopic tubing 23, 33 has been extended by the extension of hydraulic cylinders 24, 34 increasing the width of the front and rear wheels 21, 31. The excavator 80 is adapted to rotatably connect to the frame assembly 10. The frame assembly 10 may be pinned to the excavator 80 or may be connected by other suitable means that would allow the excavator to swivel with respect to the frame assembly 10. In addition to the excavator shown in FIGS. 5 and 6, the material handler 100 could be comprised of various excavators connected to the frame assembly 10 as would be appreciated by one of ordinary skill in the art having the benefit of this disclosure.

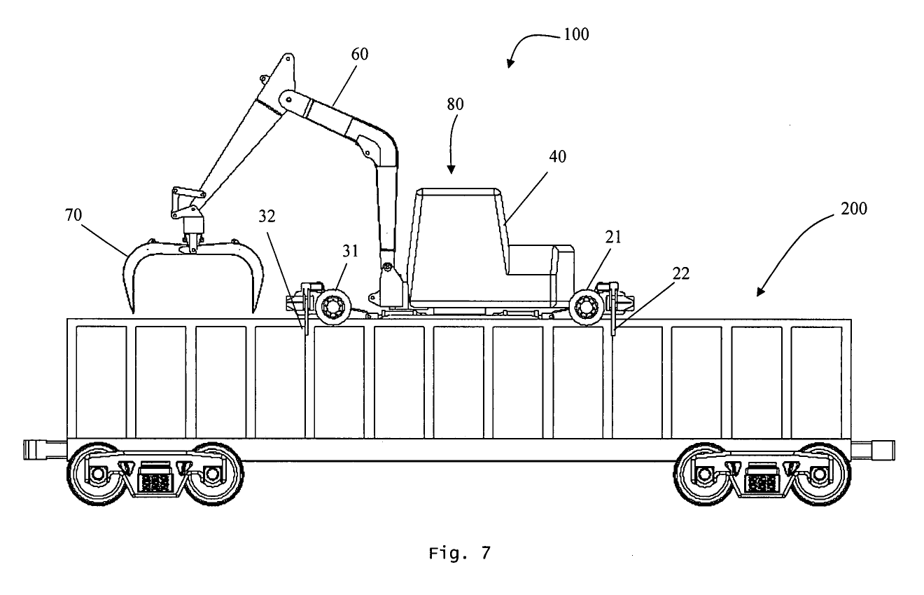

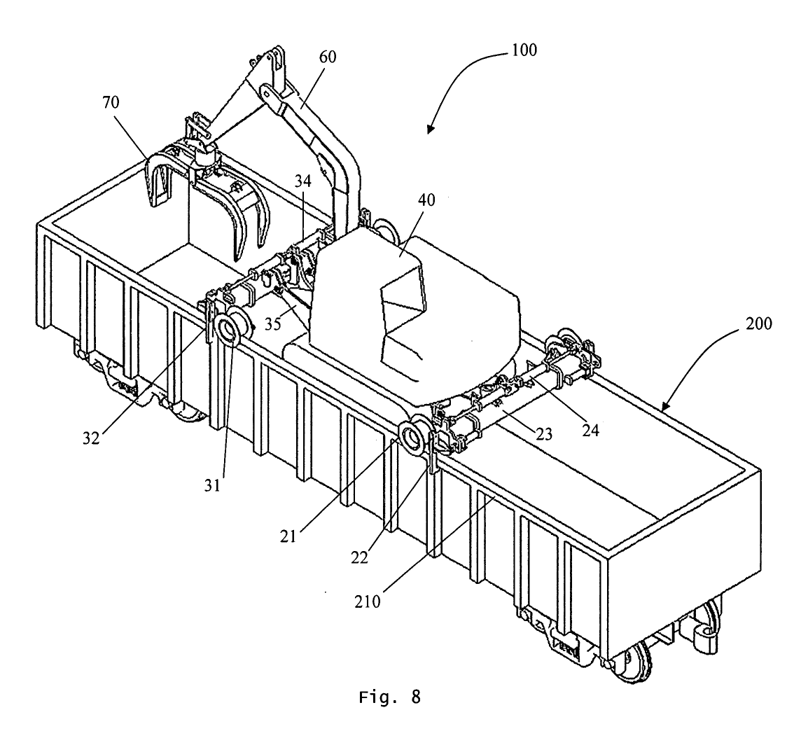

FIG. 7 shows the material handler 100 positioned on top of a gondola car 200. The excavator 80, including the cab 40, boom 60, and grapple 70 may swivel to allow the operator to load or unload material into multiple areas of the gondola car 200. While on top of the gondola car 200, clamps 22, 32 may be moved to an inward position to engage the top cord 210 of the gondola car as shown in FIG. 8. The wheels 21, 31 are adapted to ride along the top of the walls of the gondola car 200 and may move the material hander 100 from one end of the gondola car 200 to the other end. The wheels allow the material handler to move in either direction while loading and/or unloading material. The boom 60 is hydraulically controlled by the operator from the cab 40 of the excavator 80 and may be extended to reach material located away from the material handler 100. The material handler 100 shown in FIG. 7 includes a grapple 70 on the end of the boom 60, but a number of different material handling apparatus could be attached to the boom to move material as would be appreciated by one of ordinary skill in the art having the benefit of this disclosure.

FIG. 8 is an isometric view of the material handler 100 positioned on top of a gondola car 200. Clamps 22, 32 engage the top cord 210 of the gondola car 200 to ensure that the material handler 100 does not fall off the gondola car 200. The wheels 21, 31 are adapted to ride along the top of the gondola car 200 and are positioned outside of the excavator 80 to provide adequate stability of the material handler 100 while operating on top of an open top rail car. The wheels 21, 31 and swivel action of the excavator 80 provide the material handler 100 with sufficient mobility to efficiently unload the gondola car 200 even if the load of material shifts within the gondola car 200 while being unloaded.

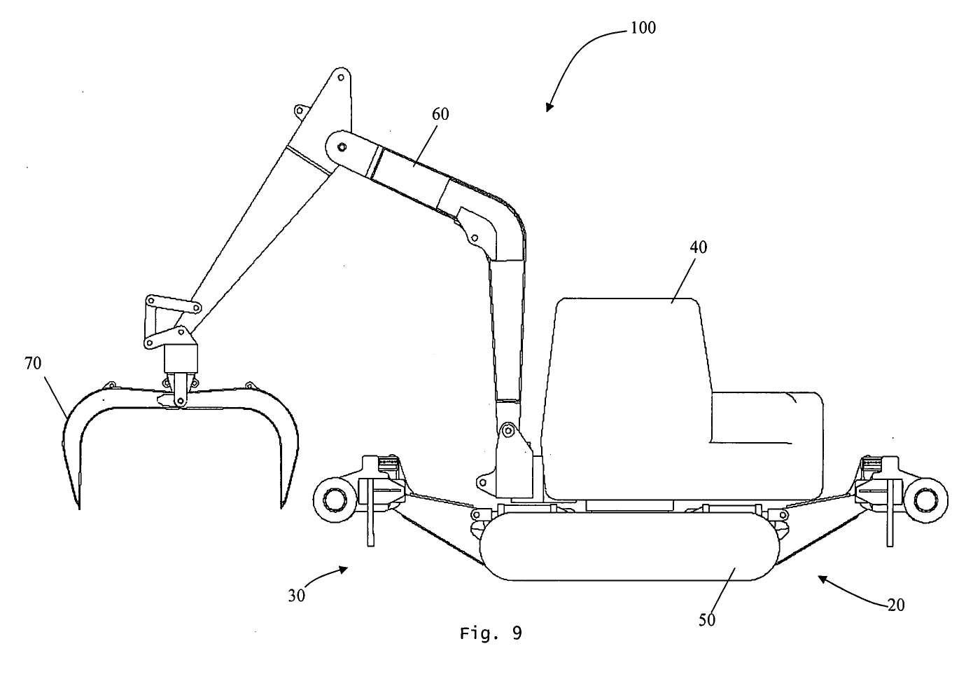

FIG. 9 shows the material handler 100 using the crawler tracks 50 to move along a flat surface such as the ground. The front wheel mount 30 and rear wheel mount 20 are raised to allow the material handler 100 to rest on the crawler tracks 50. The crawler tracks 50 may then be activated to move the material handler 100 to a desired location. The front boom 60 and grapple 70 may still be operated to move material while the material handler 100 is resting on the crawler tracks 50. Additionally, the cab 40 of the excavator 80 may also swivel while in this this mode.

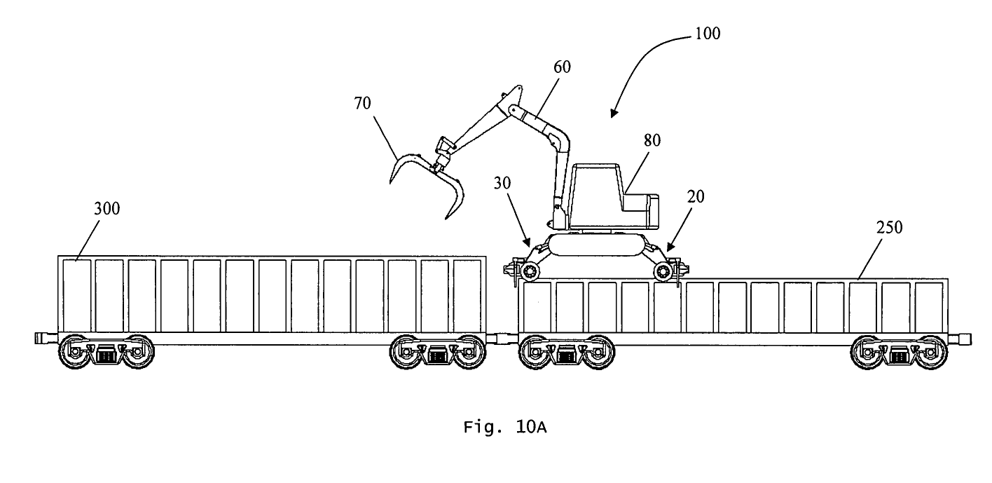

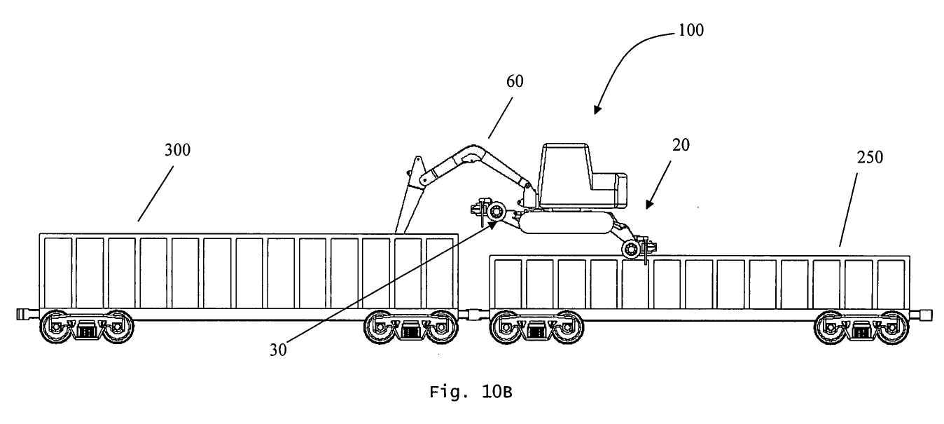

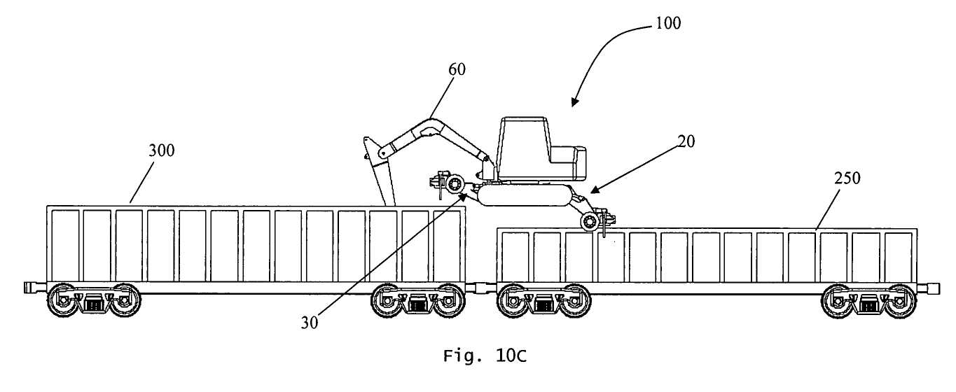

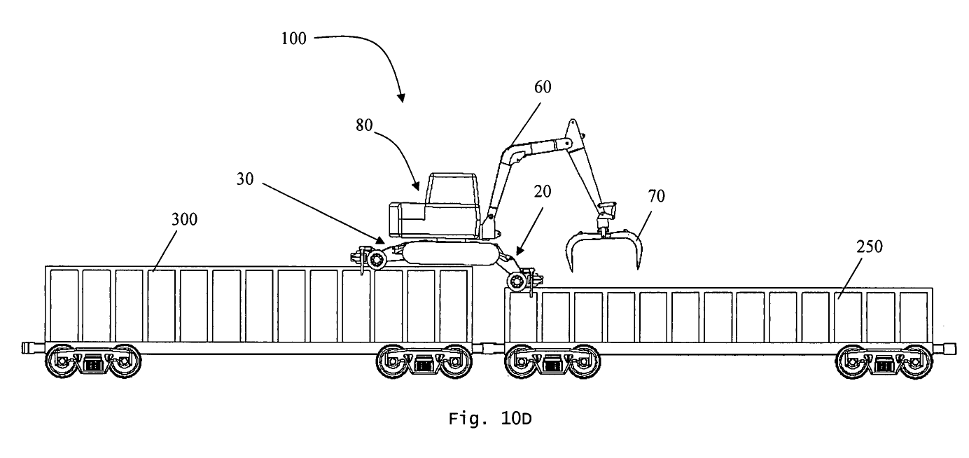

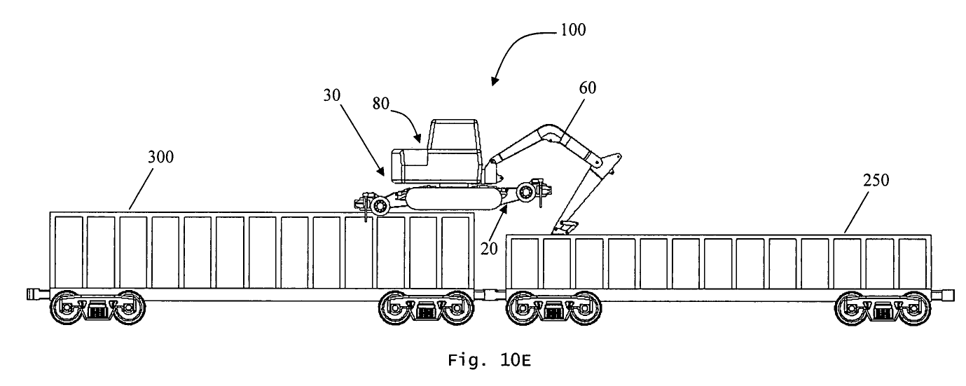

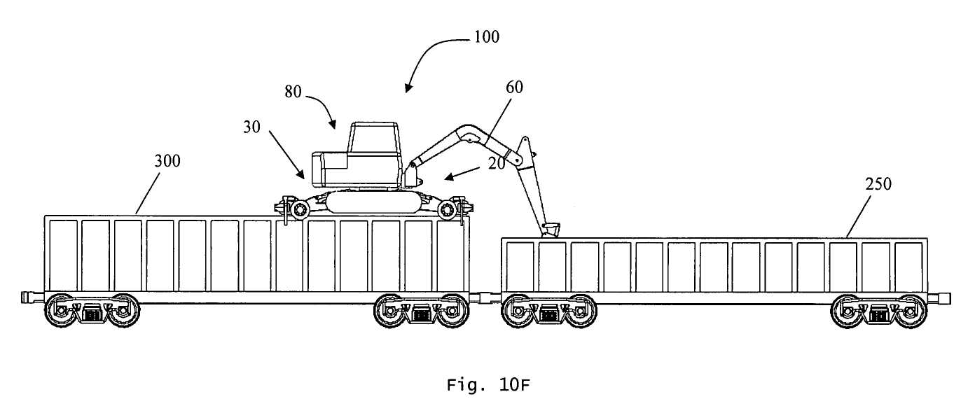

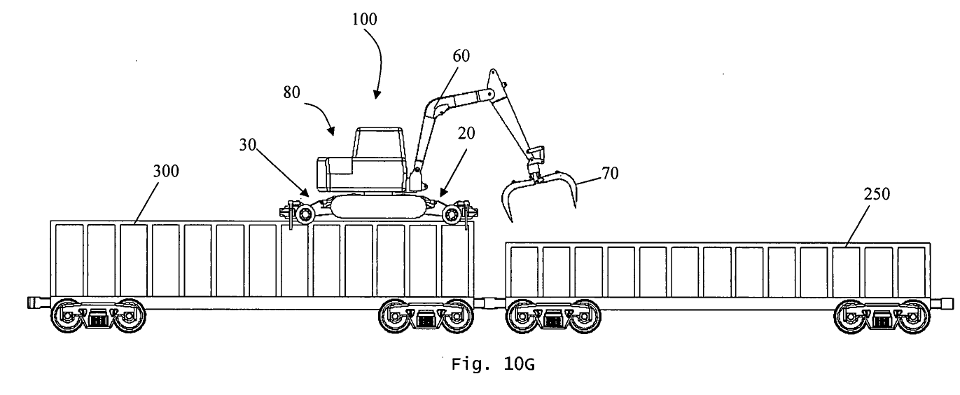

FIGS. 10A-10G show that material handler 100 traversing from a first rail car 250 to a second rail car 300 that has a higher wall height than the first rail car 250. As shown in FIG. 10A, the material handler 100 is moved until the front wheels 31 are located at the end of the first rail car 250 that is adjacent to the second rail car 300 with the boom 60 extended over the opening of the second rail car 300. Upon reaching the end of the first rail car 250, the hydraulics of the front wheel mount 30 and the rear wheel mount 20 are actuated to lower the wheel mounts 20, 30 such that the excavator 80 is raised above the rail car 250. The wheel mounts 20, 30 are lowered until the material handler 100 is level and the crawler tracks 50 of the excavator 80 are positioned higher than the top of the second rail car 300.

The boom 60 is then lowered into the second rail car 300 until the grapple 70 is positioned on the floor of the second rail car 300 as shown in FIG. 10B. Typically the boom 60 is placed approximately five feet from the first end of the second rail car 300. The boom 60 is then lowered into the second rail car 300 such that the material handler 100 is supported by the boom 60 and the rear wheal mount 20 raising the front wheels 31 off of the first rail car 250. Hydraulics 36 are then actuated to raise the front wheel mount 30 to a position that is the same height or possibly even higher than the height of the second rail car 300. The boom 60 is then curled or retracted towards the excavator 80 moving the material handler 100 towards the second rail car 300 as depicted in FIG. 10C. The rear wheels 21 of the rear wheel mount 20 will travel along the top of the first rail car 250 while the boom 60 is curled. The boom 60 is curled until the front wheels 31 of the front wheel mount 30 are positioned over the second rail car 300.

Once the front wheels 31 are over the second rail car 300, the front wheel mount 30 is lowered by hydraulics 36 until the front wheels 31 rest on the second rail car 300 lifting the boom 60 off the bottom of the second rail car 300. The heights of the front wheel mount 30 and rear wheel mount 20 may then be adjusted to level the material handler 100. The wheels 21, 31 then may be actuated to move the front of the material handler 100 forward along the second rail car 300 until the rear wheels 21 are positioned at the end of the first rail car 250 as shown in FIG. 10D. The boom 60 may then be raised and the excavator cab 40 may be rotated such that the boom 60 is positioned over the first rail car 25 also shown in FIG. 10D.

The boom 60 is then lowered into the first rail car 250 until the grapple 70 is positioned on the floor of the first rail car 250. The boom 60 is then lowered into the first rail car 250 such that the material handler 100 is supported by the boom 60 and the front wheel mount 30 raising the rear wheels 21 off of the first rail car 250 as shown in FIG. 10E. Hydraulics 26 are then actuated to raise the rear wheel mount 20 to a position that is the same height or possibly even higher than the height of the second rail car 300. The boom 60 is then uncurled or extended away from the excavator 80 moving the material handler 100 towards the second rail car 300. The front wheels 31 of the front wheel mount 30 will travel along the top of the second rail car 300 while the boom 60 is uncurled. The boom 60 is uncurled until the rear wheels 21 of the rear wheel mount 20 are positioned over the second rail car 300.

Once the rear wheels 21 are over the second rail car 300, the rear wheel mount 20 is lowered by hydraulics 26 until the rear wheels 21 rest on the second rail car 300 lifting the boom 60 off the bottom of the first rail car 250 as shown in FIG. 10F. The boom 60 may then be raised out of the first rail car 250 as depicted in FIG. 10G. The heights of the front wheel mount 30 and rear wheel mount 20 may then be adjusted to level the material handler 100. The wheels 21, 31 then may be actuated to move the material handler 100 along the second rail car 300 until the material handler 100 is located at the desired position to load or unload the second rail car 300. The wheel clamps 22, 32 may then be moved inward to engage the top cord of the second rail car 300 upon reaching the desired position.

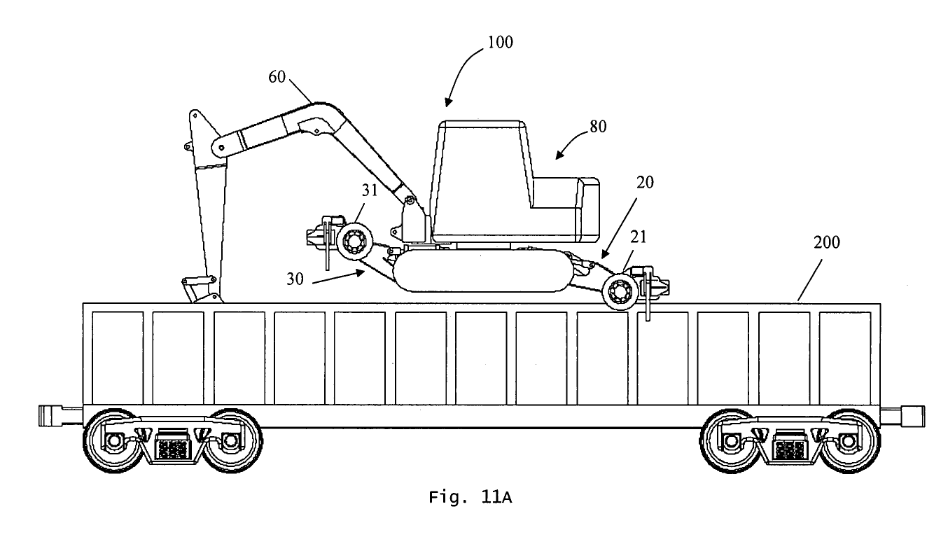

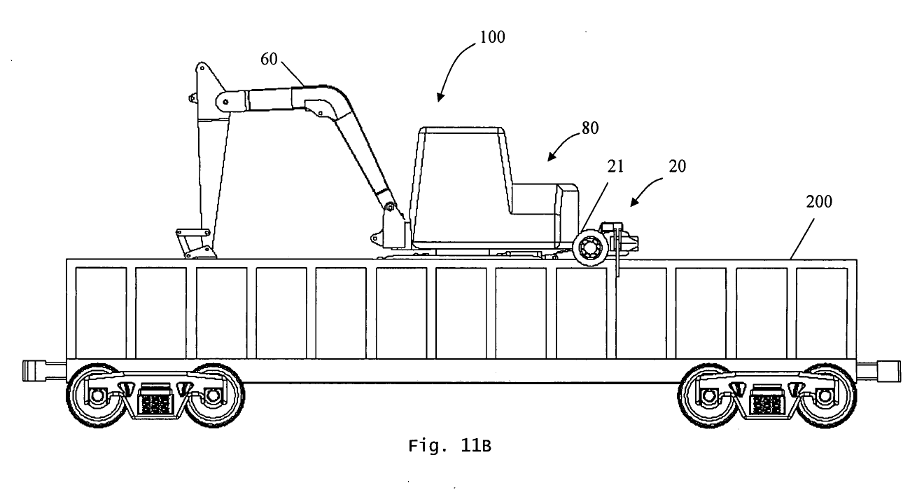

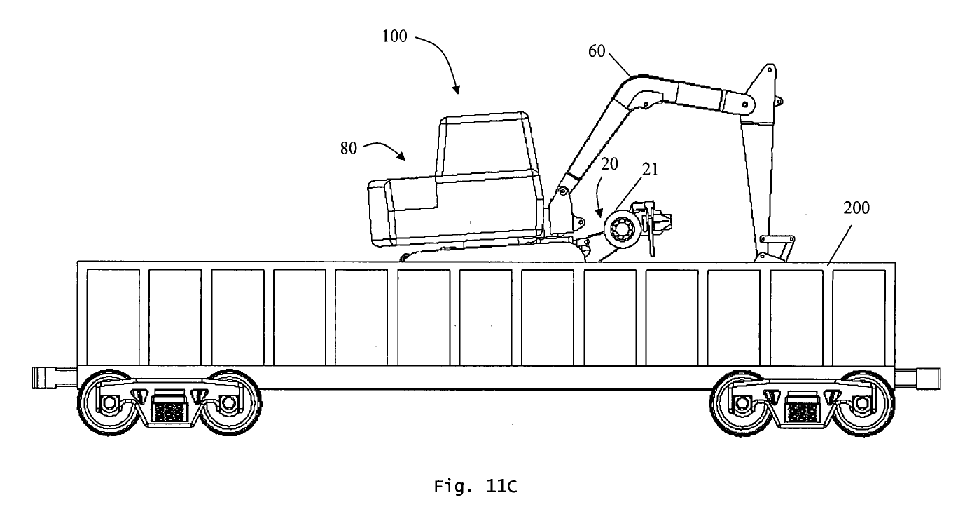

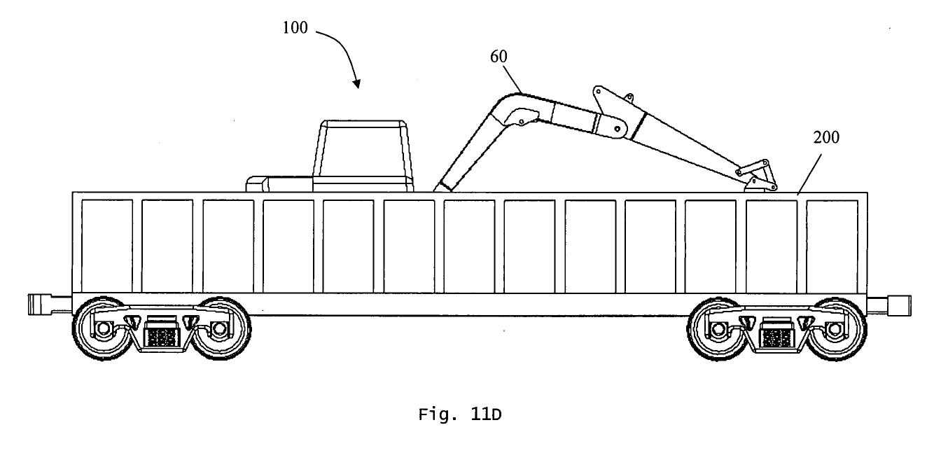

FIGS. 11A-11D depict the material handler 100 being lowered into a gondola car 200 for transportation. The first step to lower the material handler 100 is to lower the boom 60 into the rail car 200 until the grapple 70 is positioned on the floor. The boom 60 is lowered into the rail car 200 such that the material handler 100 is supported by the boom 60 and the rear wheel 20 raising the front wheels 31 off of the first rail car 200 as shown in FIG. 11A.

Hydraulics 34 can then be actuated to retract the telescopic tubing 33 of the front wheel mount 30 decreasing the width between the front wheels 31 of the front wheel mount 30. Hydraulics 36 are then actuated to lower the front wheel mount 30 below the top of the rail car 200 into the open cavity as shown in FIG. 11B. The front wheels 31 are lowered until the boom 60 is raised off of the floor of the rail car 200.

The excavator 80 may then be rotated 180 degrees such that the boom 60 is over the rear mount 20. The boom 60 is then lowered into the rail car 200 until the rear wheels 21 are lifted off of the rail car 200 as shown in FIG. 11C. Hydraulics 24 can then be actuated to retract the telescopic tubing 23 of the rear wheel mount 20 decreasing the width between the rear wheels 21 of the rear wheel mount 30. Hydraulics 26 are then actuated to lower the rear wheel mount 20 below the top of the rail car 200 into the open cavity. The boom 60 may then be uncurled moving the material handler 100 away from the grapple 70 thus, lowering the material handler 100 into the rail car 200. The boom 60 is uncurled until the rear wheels 21 rest on the floor of the rail car 200 as shown in FIG. 11D.

Although various embodiments have been shown and described, the invention is not so limited and will be understood to include all such modifications and variations as would be apparent to one skilled in the art.

What is claimed is:

1. A material handler for loading or unloading of cargo from an open top railroad car comprising:
an excavator, the excavator includes at least one boom; and
a frame assembly connected to the excavator, the frame assembly including a front wheel mount and a rear wheel mount, wherein the front wheel mount includes two front wheels and the rear wheel mount includes two rear wheels.

2. The material handler of claim 1 further comprising a first motor mounted on the frame assembly to drive at least two wheels.

3. The material handler of claim 2 further comprising a second motor mounted on the frame assembly to drive at least two additional wheels.

4. The material handler of claim 3, wherein the two front wheels and the two rear wheels move the material handler along the top portion of the open top railroad car.

5. The material handler of claim 1, wherein the front wheel mount and the rear wheel mount are adapted to independently raise or lower.

6. The material handler of claim 5, wherein the material handler it adapted to travel between two adjacent open top railroad cars having different heights.

7. The material handler of claim 6, wherein the height of the two adjacent open top railroad cars can differ up to approximately three feet.

8. The material handler of claim 1, wherein the excavator can rotate about a vertical axis with respect to the frame assembly.

9. The material handler of claim 1, wherein the width between the two front wheels and the width between the two rear wheels are adjustable.

10. The material handler of claim 9, wherein the width between the two front wheels and the width between the two rear wheels may be adjusted such that the material handler can be transported within an open top railroad car.

11. The material handler of claim 9, wherein the width between the two front wheels and the width between the two rear wheels can be adjusted up to approximately 10.5 feet.

12. The material handler of claim 1, wherein the front wheel mount includes a set of clamps for preventing excess lateral movement of the frame assembly.

13. The material handler of claim 12, wherein the rear wheel mount includes a set of clamps for preventing excess lateral movement of the frame assembly.

14. A material handler for loading and unloading an open top railroad car comprising:
an excavator;
a frame assembly, wherein the frame assembly is rotatably connected to the excavator;
a front wheel mount, the front wheel mount including two front wheels and being connected by a link to the frame assembly, wherein the width of the front wheel mount is adjustable and the front wheel mount may move vertically in respect to the assembly frame; and
a rear wheel mount, the rear wheel mount including two rear wheels and being connected by a link to the frame assembly, wherein the width of the rear wheel mount is adjustable and the rear wheel mount may move vertically in respect to the assembly frame.

15. The material handler of claim 14 further comprising at least one motor to drive the two front wheels.

16. The material handler of claim 14 further comprising at least one motor to drive the two rear wheels.

17. The material handler of claim 14, wherein the link between the front wheel mount and the frame assembly is a parallelogram link.

18. The material handler of claim 17, wherein the parallelogram link is a hydraulically or pneumatically actuated.

19. The material handler of claim 14, wherein the link between the rear wheel mount and the frame assembly is a parallelogram link.

20. The material handler of claim 19, wherein the parallelogram link is hydraulically or pneumatically actuated.

21. The material handler of claim 14, wherein the front wheel mount and the rear wheel mount are each comprised of telescopic tubing.

22. The material handler of claim 14, wherein the excavator includes a hydraulic generator.

23. The material handler of claim 22, wherein the excavator includes magnetic means for loading or unloading the open top railroad car.

24. A material handler for loading and unloading an open top railroad car comprising:
means for loading or unloading material from the open top railroad car;
a frame having a first end and a second end, wherein the frame is rotatably connected to the means for loading or unloading material;
a first means for moving the material handler along the top of the open top rail car, wherein the first means for moving the material handler is pivotably connected to the first end of the frame; and
a second means for moving the material handler along the top of the open top railroad car, wherein the second means for moving the material handler is pivotably connected to the second end of the frame.

25. The material handler of claim 24, wherein the first means for moving the material handler is a set of front wheels connected to the first end of the frame and the second means for moving a material handler is a set of rear wheels movably connected to the second end of the frame.

26. The material handler of claim 25, further comprising means for independently raising or lowering the set of front wheels with respect to the frame.

27. The material handler of claim 26, further comprising means for driving the set of front wheels.

28. The material handler of claim 26, further comprising means for driving the set of rear wheels.

29. A method of loading or unloading an open top rail car comprising:
positioning a material handler to the approximate height of the open top rail car, wherein the material handler includes a boom, a set of front wheels, and a set of rear wheels;
extending the boom into the rail car;
positioning the front end of the material handler by adjusting the position of the boom;
moving the material handler towards the rail car until the set of front wheels is over the rail car by adjusting the position of the boom;
lowering the set of front wheels onto the rail car by adjusting the position of the boom;
moving the material handler onto the rail car until the rear wheels are over the rail car by adjusting the position of the boom;
lowering the set of rear wheels onto the rail car by adjusting the position of the boom;
using the boom to load material into the rail car or to unload material out of the rail car.

30. The method of claim 29, further comprising the step of moving the material handler along the rail car.

31. The method of claim 30, wherein at least one of the set of front wheels and the set of rear wheels are used to move the material handler along the rail car.

32. The method of claim 29, wherein the width of the front wheels and width are the rear wheels is adjustable.

33. The method of claim 32, farther comprising the step of lowering the material handler into an empty open top rail car for transportation of the material handler.

34. The method of claim 29, further comprising the step of engaging a set of front clamps around a top cord of the rail car.

35. The method of claim 34, further comprising the step of engaging a set of rear clamps around a top cord of the rail car.

36. A method of transferring a material handler between a first car and a second car, wherein the first car and second car have differing wall heights comprising:
moving the material handler along the first car, wherein a first set of wheels of the material handler is located at the edge of the first car adjacent to the second car;
positioning a boom of the material handler into the second car;
lifting a first end of the material handler with the boom;
vertically positioning the first set of wheels to be aligned the wall height of the second car;
moving the material handler until the first set of wheels is located over the second car;
lowering the first end of the material handler until the first set of wheels is on the second car;
moving the material handler along the first car, wherein a second set of wheels is located at the edge of the first car adjacent to the second car;
positioning the boom of the material handler into the first car;
lifting the second end of the material handler with the boom;
vertically positioning the second set of wheels to be aligned the wall height of the second car;
moving the material handler until the second set of wheels is located over the second car; and
lowing the second end of the material handler until the second set of wheels is on the second car.

37. A frame assembly to be connected to an excavator having at least one boom, the combination for loading and unloading cargo from an open top railroad car, the frame assembly comprising:
a front wheel mount having a pair of front wheels;
a rear wheel mount having a pair of rear wheels;
a first motor for driving the pair of front wheels;
a first power unit for selectively adjusting the vertical position of the front wheel mount; and
a second power unit for selectively adjusting the width between each of the front wheels.

38. The frame assembly of claim 37 further comprising a second motor for driving the pair of rear wheels.

39. The frame assembly of claim 38 further comprising a third power unit for selectively adjusting the vertical position of the rear wheel mount.

40. The frame assembly of claim 39 further comprising a fourth power unit for selectively adjusting the width between each of the rear wheels.
